(19) United States
(12) Patent Application Publication
(10) Pub. No.: US 2020/0396598 A1
(43) Pub. Date: Dec. 17, 2020

(54) RRC Procedure Security

(71) Applicant: Apple Inc., Cupertino, CA (US)

(72) Inventors: Shu Guo, Beijing (CN); Fangli Xu, Beijing (CN); Xiangying Yang, Cupertino, CA (US); Lijia Zhang, Beijing (CN); Huarui Liang, Beijing (CN); Haijing Hu, Beijing (CN); Yuqin Chen, Shenzhen (CN); Hao Duo, Beijing (CN); Lanpeng Chen, Beijing (CN); Dawei Zhang, Saratoga, CA (US); Srinivasan Nimmala, San Jose, CA (US); Vijay Venkataraman, San Jose, CA (US); Muthukumaran Dhanapal, Dublin, CA (US); Sree Ram Kodali, Sunnyvale, CA (US)

(21) Appl. No.: 16/899,831

(22) Filed: Jun. 12, 2020

(30) Foreign Application Priority Data
Jun. 14, 2019 (CN) 201910513065.9

(51) Int. Cl. H04W 8/24; H04W 76/10; H04W 12/08

(52) U.S. Cl. CPC H04W 8/24; H04W 12/08; H04W 76/10

(57) ABSTRACT

This disclosure relates to techniques for a wireless device to perform radio resource control procedures with improved security. The wireless device may establish a radio resource control connection with a cellular base station. A capability enquiry may be received from the cellular base station. The wireless device may determine how much capability information to provide in response to the capability enquiry based at least in part on whether access stratum security has been established, either in the current radio resource connection, or in a previous radio resource connection, between the wireless device and the cellular base station when the capability enquiry is received.

### PRIORITY DATA

This application claims benefit of priority to Chinese Application No. 201910513065.9, titled “Improved RRC Procedure Security”, filed Jun. 14, 2019, which is hereby incorporated by reference in its entirety as though fully and completely set forth herein.

### FIELD

The present application relates to wireless communications, and more particularly to systems, apparatuses, and methods for a wireless device to perform RRC procedures with improved security.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include GSM, UMTS (associated with, for example, WCDMA or TD-SCDMA air interfaces), LTE, LTE Advanced (LTE-A), NR, HSPA, 3GPP2 CDMA2000 (e.g., 1×RTT, 1×EV-DO, HRPD, eHRPD), IEEE 802.11 (WLAN or Wi-Fi), BLUETOOTH™, etc.

The ever increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. Additionally, it is important to minimize opportunities for unauthorized parties to tamper with such wireless communications. Accordingly, improvements in the field are desired.

### SUMMARY

Embodiments are presented herein of apparatuses, systems, and methods for a wireless device to perform RRC procedures with improved security.

According to the techniques described herein, a wireless device may limit its provision of capability information in response to a capability enquiry from a serving cell when access stratum security has not yet been established. For example, as one possibility, capability enquiry and capability information messages may not be performed prior to establishing access stratum security, and if a wireless device does receive a capability enquiry prior to establishing access stratum security with a cell, it may be the case that the wireless device declares radio link failure.

As another possibility, under some circumstances a wireless device may provide partial or reduced capability information in response to a capability enquiry that is received prior to establishing access stratum security. The partial/reduced capability information could include sufficient information to facilitate network resource configuration for the wireless device, while avoiding providing (or indicating lower-than-actual) capability information for features that may be relatively more sensitive or vulnerable, such as those which could be activated by a cell in idle mode or otherwise prior to establishing access stratum security.

A wireless device implementing such an approach may still provide full capability information to a capability enquiry that is received after establishing access stratum security. Additionally, it may be possible for the wireless device to store information indicating cells with which access stratum security has previously successfully been established, and to provide full capability information to a capability enquiry that is received from such a cell even prior to establishing access stratum security.

In such an approach, it may be possible for the wireless device to detach and re-attach to a cell after establishing security if partial or reduced capability information was provided during the initial connection setup, e.g., to facilitate updating the cell with more complete capability information. For example, in such a scenario, the wireless device may store information indicating that the cell is secure based on the successful security establishment, such that upon receiving a capability enquiry after re-attaching, the wireless device may provide full capability information to the cell. Alternatively, the device may perform a periodic REGISTRATION UPDATE procedure, with the ‘Radio Capability Update’ flag set to TRUE.

Partially or completely limiting the capability information provided in response to a capability enquiry that is received prior to security establishment, such as in any of the ways described herein, may help protect user privacy and device functionality, at least according to some embodiments.

Note that the techniques described herein may be implemented in and/or used with a number of different types of devices, including but not limited to base stations, access points, cellular phones, portable media players, tablet computers, wearable devices, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

FIG. 1 illustrates an exemplary (and simplified) wireless communication system, according to some embodiments;

FIG. 2 illustrates an exemplary base station in communication with an exemplary wireless user equipment (UE) device, according to some embodiments;

FIG. 3 illustrates an exemplary block diagram of a UE, according to some embodiments;

FIG. 4 illustrates an exemplary block diagram of a base station, according to some embodiments;

FIG. 5 is a flowchart diagram illustrating aspects of an exemplary possible method for a wireless device to perform RRC procedures with improved security, according to some embodiments;

FIGS. 6-7 illustrate aspects of a possible scenario in which insecure RRC procedures could be used to breach a user's privacy, according to some embodiments; and

FIGS. 8-13 are signal flow diagrams illustrating possible aspects of techniques for performing RRC procedures with improved security, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology

### Terms

The following is a glossary of terms that may appear in the present disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer system for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” may be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or may be stationary or fixed at a certain location. A UE is an example of a wireless device.

Communication Device—any of various types of computer systems or devices that perform communications, where the communications can be wired or wireless. A communication device can be portable (or mobile) or may be stationary or fixed at a certain location. A wireless device is an example of a communication device. A UE is another example of a communication device.

Base Station (BS)—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, e.g., in a user equipment device or in a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

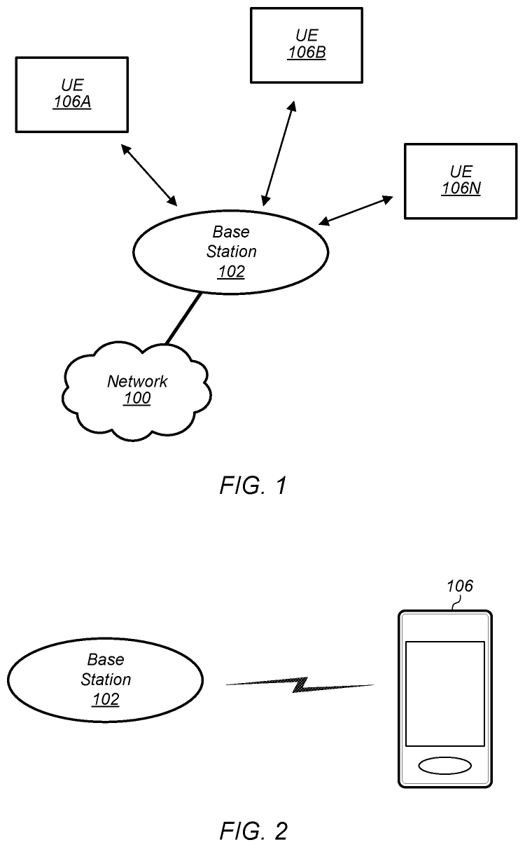

### FIGS. 1 and 2—Exemplary Communication System

FIG. 1 illustrates an exemplary (and simplified) wireless communication system in which aspects of this disclosure may be implemented, according to some embodiments. It is noted that the system of FIG. 1 is merely one example of a possible system, and embodiments may be implemented in any of various systems, as desired.

As shown, the exemplary wireless communication system includes a base station 102 which communicates over a transmission medium with one or more (e.g., an arbitrary number of) user devices 106A, 106B, etc. through 106N. Each of the user devices may be referred to herein as a “user equipment” (UE) or UE device. Thus, the user devices 106 are referred to as UEs or UE devices.

The base station 102 may be a base transceiver station (BTS) or cell site, and may include hardware and/or software that enables wireless communication with the UEs 106A through 106N. If the base station 102 is implemented in the context of LTE, it may alternately be referred to as an ‘eNodeB’ or ‘eNB’. If the base station 102 is implemented in the context of 5G NR, it may alternately be referred to as a ‘gNodeB’ or ‘gNB’. The base station 102 may also be equipped to communicate with a network 100 (e.g., a core network of a cellular service provider, a telecommunication network such as a public switched telephone network (PSTN), and/or the Internet, among various possibilities). Thus, the base station 102 may facilitate communication among the user devices and/or between the user devices and the network 100. The communication area (or coverage area) of the base station may be referred to as a “cell.” As also used herein, from the perspective of UEs, a base station may sometimes be considered as representing the network insofar as uplink and downlink communications of the UE are concerned. Thus, a UE communicating with one or more base stations in the network may also be interpreted as the UE communicating with the network.

The base station 102 and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), LAA/LTE-U, 5G NR, 3GPP2 CDMA2000 (e.g., 1×RTT, 1×EV-DO, HRPD, eHRPD), Wi-Fi, etc.

Base station 102 and other similar base stations operating according to the same or a different cellular communication standard may thus be provided as one or more networks of cells, which may provide continuous or nearly continuous overlapping service to UE 106 and similar devices over a geographic area via one or more cellular communication standards.

Note that a UE 106 may be capable of communicating using multiple wireless communication standards. For example, a UE 106 might be configured to communicate using either or both of a 3GPP cellular communication standard or a 3GPP2 cellular communication standard. In some embodiments, the UE 106 may be configured to perform RRC procedures with improved security such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an exemplary user equipment 106 (e.g., one of the devices 106A through 106N) in communication with the base station 102, according to some embodiments. The UE 106 may be a device with wireless network connectivity such as a mobile phone, a hand-held device, a wearable device, a computer or a tablet, or virtually any type of wireless device. The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 may be configured to communicate using any of multiple wireless communication protocols. For example, the UE 106 may be configured to communicate using two or more of CDMA2000, LTE, LTE-A, 5G NR, WLAN, or GNSS. Other combinations of wireless communication standards are also possible.

The UE 106 may include one or more antennas for communicating using one or more wireless communication protocols according to one or more RAT standards. In some embodiments, the UE 106 may share one or more parts of a receive chain and/or transmit chain between multiple wireless communication standards. The shared radio may include a single antenna, or may include multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware.

In some embodiments, the UE 106 may include separate transmit and/or receive chains (e.g., including separate antennas and other radio components) for each wireless communication protocol with which it is configured to communicate. As a further possibility, the UE 106 may include one or more radios that are shared between multiple wireless communication protocols, and one or more radios that are used exclusively by a single wireless communication protocol. For example, the UE 106 may include a shared radio for communicating using either of LTE or CDMA2000 1×RTT (or LTE or NR, or LTE or GSM), and separate radios for communicating using each of Wi-Fi and BLUETOOTH′. Other configurations are also possible.

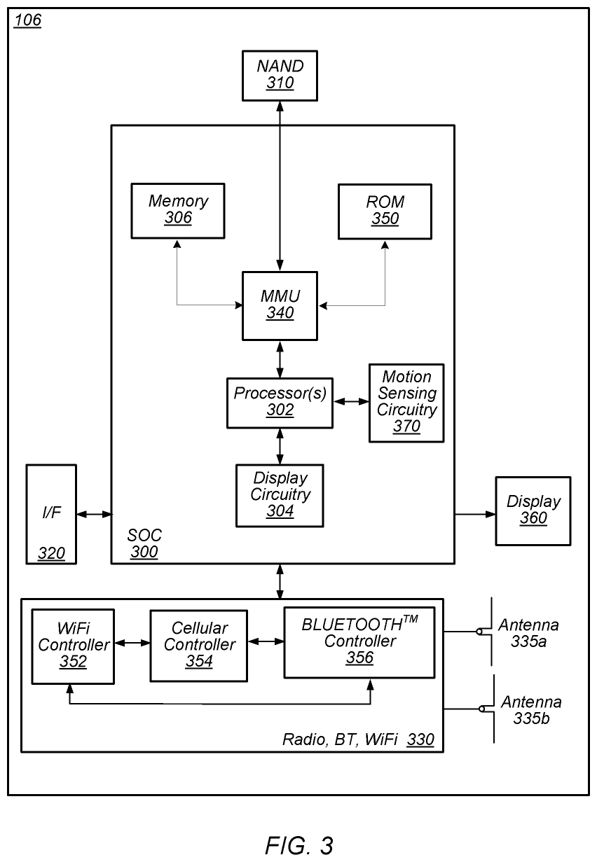

### FIG. 3—Block Diagram of an Exemplary UE Device

FIG. 3 illustrates a block diagram of an exemplary UE 106, according to some embodiments. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 360. The SOC 300 may also include motion sensing circuitry 370 which may detect motion of the UE 106, for example using a gyroscope, accelerometer, and/or any of various other motion sensing components. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including NAND flash 310), a connector interface 320 (e.g., for coupling to a computer system, dock, charging station, etc.), the display 360, and wireless communication circuitry 330 (e.g., for LTE, LTE-A, NR, CDMA2000, BLUETOOTH™, Wi-Fi, GPS, etc.). The UE device 106 may include at least one antenna (e.g. 335a), and possibly multiple antennas (e.g. illustrated by antennas 335a and 335b), for performing wireless communication with base stations and/or other devices. Antennas 335a and 335b are shown by way of example, and UE device 106 may include fewer or more antennas. Overall, the one or more antennas are collectively referred to as antenna 335. For example, the UE device 106 may use antenna 335 to perform the wireless communication with the aid of radio circuitry 330. As noted previously herein, the UE may be configured to communicate wirelessly using multiple wireless communication standards in some embodiments.

The UE 106 may include hardware and software components for implementing methods for the UE 106 to perform RRC procedures with improved security such as described further subsequently herein. The processor(s) 302 of the UE device 106 may be configured to implement part or all of the methods described herein, e.g., by executing program instructions stored on a memory medium (e.g., a non-transitory computer-readable memory medium). In other embodiments, processor(s) 302 may be configured as a programmable hardware element, such as an FPGA (Field Programmable Gate Array), or as an ASIC (Application Specific Integrated Circuit). Furthermore, processor(s) 302 may be coupled to and/or may interoperate with other components as shown in FIG. 3, to perform RRC procedures with improved security according to various embodiments disclosed herein. Processor(s) 302 may also implement various other applications and/or end-user applications running on UE 106.

In some embodiments, radio 330 may include separate controllers dedicated to controlling communications for various respective RAT standards. For example, as shown in FIG. 3, radio 330 may include a Wi-Fi controller 352, a cellular controller (e.g. LTE and/or LTE-A controller) 354, and BLUETOOTH™ controller 356, and in at least some embodiments, one or more or all of these controllers may be implemented as respective integrated circuits (ICs or chips, for short) in communication with each other and with SOC 300 (and more specifically with processor(s) 302). For example, Wi-Fi controller 352 may communicate with cellular controller 354 over a cell-ISM link or WCI interface, and/or BLUETOOTH™ controller 356 may communicate with cellular controller 354 over a cell-ISM link, etc. While three separate controllers are illustrated within radio 330, other embodiments have fewer or more similar controllers for various different RATs that may be implemented in UE device 106.

Further, embodiments in which controllers may implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

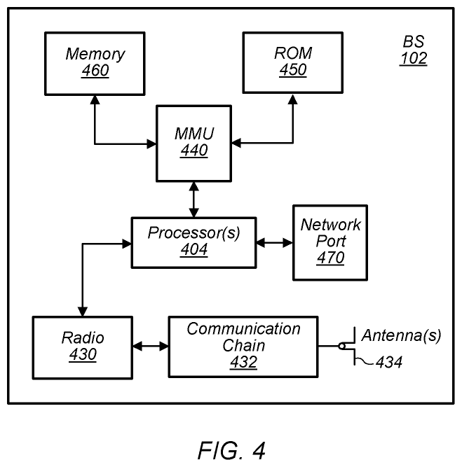

### FIG. 4—Block Diagram of an Exemplary Base Station

FIG. 4 illustrates a block diagram of an exemplary base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2. The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

The base station 102 may include at least one antenna 434, and possibly multiple antennas. The antenna(s) 434 may be configured to operate as a wireless transceiver and may be further configured to communicate with UE devices 106 via radio 430. The antenna(s) 434 communicates with the radio 430 via communication chain 432. Communication chain 432 may be a receive chain, a transmit chain or both. The radio 430 may be designed to communicate via various wireless telecommunication standards, including, but not limited to, NR, LTE, LTE-A WCDMA, CDMA2000, etc. The processor 404 of the base station 102 may be configured to implement and/or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. In the case of certain RATs, for example Wi-Fi, base station 102 may be designed as an access point (AP), in which case network port 470 may be implemented to provide access to a wide area network and/or local area network (s), e.g. it may include at least one Ethernet port, and radio 430 may be designed to communicate according to the Wi-Fi standard.

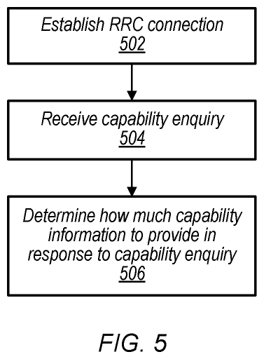

FIG. 5—RRC Procedures with Improved Security

FIG. 5 is a flowchart diagram illustrating a method for a wireless device (e.g., a wireless user equipment (UE) device, as one possibility) to perform RRC procedures with improved security, according to some embodiments.

Aspects of the method of FIG. 5 may be implemented by a wireless device, e.g., in conjunction with one or more cellular base stations, such as a UE 106 and a BS 102 illustrated in and described with respect to various of the Figures herein, or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Note that while at least some elements of the method of FIG. 5 are described in a manner relating to the use of communication techniques and/or features associated with LTE, LTE-A, NR, and/or 3GPP specification documents, such description is not intended to be limiting to the disclosure, and aspects of the method of FIG. 5 may be used in any suitable wireless communication system, as desired. In various embodiments, some of the elements of the methods shown may be performed concurrently, in a different order than shown, may be substituted for by other method elements, or may be omitted. Additional method elements may also be performed as desired. As shown, the method of FIG. 5 may operate as follows.

In 502, a wireless device may establish a wireless link with a cellular base station. According to some embodiments, the wireless link may include a cellular link according to long term evolution (LTE). For example, the wireless device may establish a session with a mobility management entity of the cellular network by way of an eNB that provides radio access to the cellular network. As another possibility, the wireless link may include a cellular link according to 5G NR. For example, the wireless device may establish a session with an AMF entity of the cellular network by way of a gNB that provides radio access to the cellular network. There may also be deployments in which devices are able to establish a session with an AMF by way of an eNB (e.g., eLTE deployments). Other types of cellular links are also possible, and the cellular network may also or alternatively operate according to another cellular communication technology (e.g., UMTS, CDMA2000, GSM, etc.), according to various embodiments.

Establishing the wireless link may include establishing a RRC connection with a serving cellular base station, at least according to some embodiments. Establishing the RRC connection may include configuring various parameters for communication between the wireless device and the cellular base station, establishing context information for the wireless device, and/or any of various other possible features, e.g., relating to establishing an air interface for the wireless device to perform cellular communication with a cellular network associated with the cellular base station. After establishing the RRC connection, the wireless device may operate in a RRC connected state. In some instances, the RRC connection may also be released (e.g., after a certain period of inactivity with respect to data communication), in which case the wireless device may operate in a RRC idle state or a RRC inactive state. In some instances, the wireless device may perform handover (e.g., while in RRC connected mode) or cell re-selection (e.g., while in RRC idle or RRC inactive mode) to a new serving cell, e.g., due to wireless device mobility, changing wireless medium conditions, and/or for any of various other possible reasons.

In 504, the wireless device may receive a capability enquiry from the serving cellular base station. The capability enquiry may be received during an initial cell access by a wireless device, or at any of various other times, e.g., after RRC connection setup is complete. As one possibility, the capability enquiry may be received while access stratum security has not been established (e.g., prior to access stratum security establishment). As another possibility, the capability enquiry may be received while access stratum security has been established (e.g., after access stratum security establishment).

In 506, the wireless device may determine how much capability information to provide in response to the capability enquiry. The wireless device may determine how much capability information to provide in response to the capability enquiry based at least in part on whether access stratum security has been established with the serving cellular base station of the wireless device when the capability enquiry is received.

For example, in some embodiments, capability enquiries may be disallowed when access stratum security has not been established. In such a scenario, the wireless device may determine to not provide capability information for the wireless device to the serving cellular base station in response to the capability enquiry if access stratum security has not been established between the wireless device and the serving cellular base station when the capability enquiry is received. In some instances, the wireless device may further declare radio link failure if access stratum security has not been established between the wireless device and the cellular base station when the capability enquiry is received, e.g., since such an enquiry may fall outside of specified cell behavior. If access stratum security has been established between the wireless device and the cellular base station when the capability enquiry is received, in contrast, the wireless device may determine to provide capability information for the wireless device to the serving cellular base station in response to the capability enquiry, and so may provide the capability information to the serving cellular base station.

Alternatively, as strictly disallowing wireless device capability enquiries and providing wireless device capability information prior to access stratum security establishment could potentially impact the ability of the cellular network to appropriately configure network resources for a wireless device, in some instances it may be possible for a wireless device to respond to a capability enquiry that is received while access stratum security has not been established with partial and/or reduced capability information for the wireless device. For example, partial capability information (e.g., with some selected types of capability information for the wireless device omitted) that may be sufficient to support configuration by the network of at least a minimum network resource set for the wireless device could be provided. Additionally or alternatively, reduced capability information could indicate a lower capability than the actual capability of the wireless device with respect to one or more types of capability information, such as an access stratum release capability. Providing such partial/reduced capability information for the wireless device in response to a capability enquiry that is received while access stratum security has not been established, e.g., instead of no capability information or full capability information, may help support prompt network configuration for the wireless device while still protecting user privacy and/or reducing vulnerability of features that could be enabled or activated while access stratum security establishment has not been completed (e.g., features that could be enabled or activated in RRC idle mode, as one possibility).

Thus, in such a scenario, it may be the case that the wireless device determines to provide partial and/or reduced capability information to the cellular base station if access stratum security has not been established between the wireless device and the cellular base station, and so may provide the partial/reduced capability information to the serving cellular base station. If access stratum security has been established between the wireless device and the cellular base station when the capability enquiry is received, the wireless device may determine to provide full capability information for the wireless device to the serving cellular base station in response to the capability enquiry, and so may provide the full capability information to the serving cellular base station.

In some instances, it may also be possible for the wireless device to consider whether it has previously established access stratum security with a cell when determining how much capability information to provide in response to the capability enquiry. For example, whenever the wireless device establishes access stratum security with a cellular base station, the wireless device could store information indicating that the wireless device has established access stratum security with that cellular base station previously, e.g., by storing a global cell identifier (such as a public land mobile network identifier and cell identifier combination) for the cell in a database or other memory structure of the wireless device. Such storage could be non-volatile, e.g., such that it may persist across power on/off cycles, according to some embodiments. For such cells, the wireless device may determine to provide full capability information to the wireless device even while access stratum security has not been established between the wireless device and the cellular base station based at least in part on determining that the wireless device has previously established access stratum security with the cellular base station, e.g., since previous successful access stratum security establishment may be considered an indicator of a cell that may be secure, and so may provide the full capability information to the serving cellular base station.

In some instances, it may occur that the wireless device and the serving cellular base station establish access stratum security after the wireless device has responded to the capability enquiry with partial/reduced capability information for the wireless device. In such a case, the wireless device may add the cell to its list of secure cells (e.g., those with which the wireless device has previously established access stratum security), and may initiate a detach procedure and an attach procedure to re-attach to the cell, or perform a Tracking Area Update procedure with a ‘Radio Capability Update’ flag set to TRUE, e.g., to facilitate provision of full capability information for the wireless device to the cell. For example, after detaching from and re-attaching to the serving cellular base station, the wireless device may receive a further capability enquiry from the serving cellular base station, may determine to provide full capability information in response to the capability enquiry, e.g., based at least in part on having previously established access stratum security with the cell, and may provide the full capability information for the wireless device to the serving cellular base station.

Additionally or alternatively to limiting wireless device capability information that is provided while access stratum security has not been established, it may be the case that the wireless device limits one or more types of wireless device assistance information from being provided while access stratum security has not been established. For example, at least some wireless device assistance information, such as assistance information that could relate to power saving feature/parameter preferences (e.g., connected mode discontinuous reception configuration preferences, coverage enhanced mode configuration preferences), delay budget reports, etc., could be used by an unauthorized party to determine device type and/or other information about a device if transmitted in an unsecured manner. Accordingly, in some embodiments, the wireless device may determine whether to provide wireless device assistance information to the cellular base station based at least in part on whether access stratum security has been established between the wireless device and the cellular base station (e.g., currently or on any previous occasion). For example, the wireless device may determine to not provide wireless device assistance information to a serving cellular base station if access stratum security has not been established between the wireless device and the cellular base station and if the wireless device has not previously established access stratum security with the cellular base station.

As described herein, use of the techniques of the method of FIG. 5 for determining whether to provide capability and assistance information and how much capability information to provide based on whether access stratum security has been established between a wireless device and a cellular base station may result in improved security for RRC procedures. In particular, such techniques may help reduce the likelihood that wireless device capability information could be used by unauthorized parties for user location tracking, privacy infringement, bidding down attacks, denial of service attacks, and/or other potentially harmful activities, at least according to some embodiments.

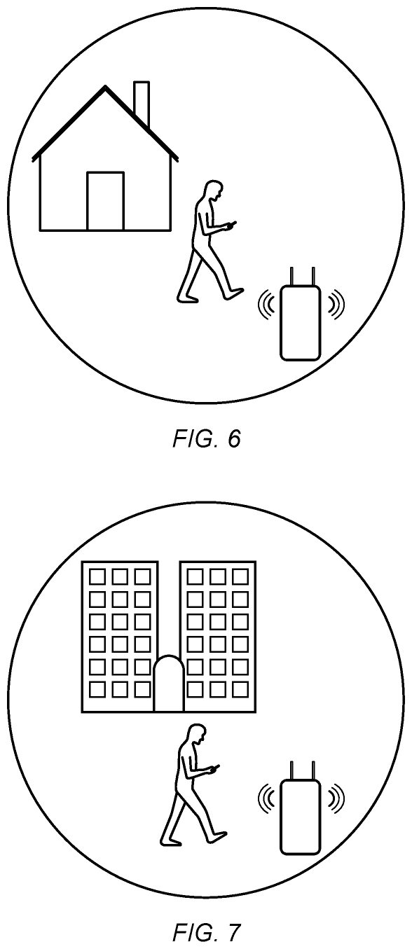

### FIGS. 6-13—Additional Information

FIGS. 6-13 and the following information are provided as being illustrative of further considerations and possible implementation details relating to the method of FIG. 5, and are not intended to be limiting to the disclosure as a whole. Numerous variations and alternatives to the details provided herein below are possible and should be considered within the scope of the disclosure.

Security is generally a high priority in cellular communication, and efforts are typically made to provide strong security procedures and reduce security vulnerabilities when discovered. Various techniques that have been possible for tracking a user's location in LTE have been resolved in later LTE releases and/or in NR. For example, in NR, the use of a subscription permanent identifier (SUPI) and a subscription concealed identifier (SUCI) has been introduced to address international mobile subscription identity (IMSI) catching. As another example, mandating that measurements reports be provided with security in LTE later releases has resolved the possibility that an unauthorized party could obtain UE measurement reports. As a still further example, UEs send their temporary identities in plain text at connection establishment, such that if they are not updated sufficiently frequently, it may be possible for an unauthorized party to track UE location using the temporary identity. Accordingly, to mitigate this possibility, the frequency at which temporary identities are updated has been increased in LTE later releases and in NR, for example including updating the temporary identity as part of every service request/registration request in NR.

Once an RRC security mode command procedure is completed, all messages transmitted between a wireless device and its serving cell may need to have integrity and cipher protection. Thus, once security is activated, all RRC messages on signaling radio bearer 1 (SRB1) and signaling radio bearer 2 (SRB2), including those containing non-access stratum (NAS) or non-3GPP messages, are integrity protected and ciphered by PDCP. Additionally, the NAS may independently apply integrity protection and ciphering to the NAS messages.

A UE may process some RRC messages before security is activated, e.g., to facilitate connection establishment, while it may be the case that some messages can be received/transmitted only after security is activated. For example, it may be the case that the E-UTRAN will apply both ciphering and integrity protection for the RRC connection reconfiguration messages used to establish SRB2 and data radio bearers (DRBs). As another example, while during the initial phase of an RRC connection, the E-UTRAN may configure a UE to perform measurement reporting, it may be the case that the UE only sends the corresponding measurement reports after successful security activation. As still another example, it may be the case that a UE only accepts a handover message when security has been activated. As yet another example, it may be the case that the E-UTRAN only initiates a UE Information Request by sending a UEInformationRequest message after successful security activation.

However, at least according to some embodiments, it may be the case that UE capability enquiry messages and UE capability information messages can be transmitted even without any security. For example, in the 3GPP RAN2 R15 specification document TS 38.331, B.1 Protection of RRC messages, it is specified that the UECapabilityEnquiry message and the UECapabilityInformation message can be sent before or after access stratum (AS) security activation, such that such messages can be sent unprotected prior to AS security activation.

As a result, one possibility that could still lead to user location tracking, at least in some embodiments, could include using such UE capability information. FIGS. 6-7 illustrate aspects of a scenario in which such user location tracking could be performed. In such a scenario, an unauthorized party could place small cells at a user's home and office locations, such as illustrated in FIG. 6 and in FIG. 7 respectively. The small cells could be configured with a different tracking area than the cells of any available authorized networks, and may be deployed such that signal strength for the small cells is relatively high at the targeted locations, such that UEs in those locations may re-select to them. When a tracking area update (TAU) is provided from the user's device to one of the small cells, the small cell may be able to query the user's device for UE capability information. Even though RRC security may not be activated yet (and may never be activated, since the cell may be unauthorized), the user's device may respond to the small cell with UE capability information for the device in plain text.

At least in some instances, if such UE capability information is provided in sufficient detail (e.g., including band capabilities, carrier aggregation combinations, and/or other characteristics), it may be possible to effectively identify a specific device type. In some instances, user preferences (e.g., disabling a certain RAT, etc.) could also be reflected in the UE capability information, which could further identify a specific device. Still further, in some instances information regarding in-device co-existence and/or UE assistance information (e.g., indicating power preference information) that could similarly be transmitted in plain text when security has not yet been activated, could further help fine tune device identification.

Thus, in such a scenario, an unauthorized party could determine whether a user's device is in the vicinity of one of the small cells deployed by the unauthorized party as a tool to track that user's location. In addition to potential for such use for privacy leaking, tampering on the UE capability information could be performed to commit a bidding down attack, e.g., to limit the UE's radio capability.

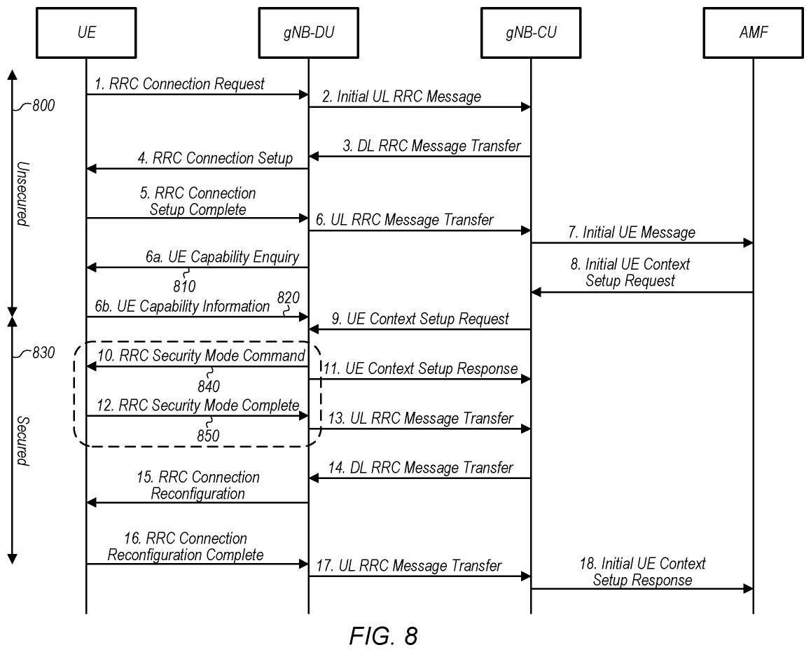

FIG. 8 is a signaling flow diagram illustrating how a UECapability Enquiry and UECapability Information could be sent before the AS security mode command is complete during UE initial access. As shown, in the illustrated scenario, the UE Capability Enquiry message 810 and the UE Capability Information message 820 are both sent during the unsecured portion 800 of the signaling flow, and are followed by the secured portion 830 of the signaling flow, which begins with the RRC security mode command message 840 and the RRC security mode complete message 850.

Some of the NR idle mode features, such as Multi Frequency Band Indicator (MFBI), for example, may have a capability information element (IE) in a RRC UE Capability Information message. Since, as previously noted, it may be the case that capability information is not mandated to be exchanged after UE security establishment procedure, there could also be a possibility of mis-use of such information to cause a denial of service (DOS) to a user. For example, an unauthorized party could change the content of a broadcast message by incorrectly introducing the MFBI feature IEs in system information block 1 (SIB1), thereby causing a UE to perform a MFBI frequency band conversion and camp on an altogether different band/physical E-UTRA Absolute Radio Frequency Channel Number (EARFCN)/cell, which may not be secured. While it may be the case that the UE does not establish a connection onto such a fake cell, the UE could camp on the cell as part of cell selection/re-selection, which may not be secured, and so remain camped on a cell from which the UE is not able to obtain its normal service. The UE may thus end up missing incoming calls and messages, at least in some scenarios.

Further, more generally, it may be possible to use such unsecured UE capability information to obtain sensitive information about a specific device type, such as the UE's specific capabilities with respect to which LTE/NR bands are supported by the UE, which carrier aggregation combinations are supported by the UE, a category of the UE, which is the maximum 3 GPP release version supported by the UE, a type of the UE according to NR, and/or any of various other information that may be included in the unsecured UE capability information.

Accordingly, as one possibility, it may be beneficial to limit the types of RRC messages that can be transmitted prior to security activation, e.g., such that UE capability enquiry and UE capability information messages are not allowed prior to security activation. At least in some instances, it may be the case that such an approach may have a minimal impact on user experience. For example, as previously noted, many procedures are already disallowed prior to security activation, including handovers, so requiring security for sending UE capability enquiry and UE capability information messages may not increase latency for such procedures (e.g., handover, circuit switched fallback (CSFB), etc.). For some types of information that might be provided as part of UE capability information, such as device category (e.g., if a device is Cat-M), where indicating this information may assist the network to better support the device, it may be possible to provide such information through other means, such as using a physical random access channel (PRACH) procedure preamble selected to indicate the device category. As another example, limiting UE capability enquiry and UE capability information messages to being transmitted after security may have a limited impact on carrier aggregation or dual connectivity set up time, since data radio bearers are already limited to only being set up with security, at least according to some embodiments.

Thus, using such an approach, it may be the case that the RRC layer of a UE may be configured to process only a limited set of messages without integrity and ciphering protection. For example, the limited set of messages could include RRC connection request/setup/setup complete messages, uplink/downlink information transfer messages, RRC connection release messages, RRC connection reject messages, and RRC connection re-establishment reject messages. In such a scenario, if the network requests that the UE send any other message (e.g., including sending a UE capability enquiry that requests UE capability information), the UE may trigger radio link failure (RLF). Alternatively, the UE may simply limit itself to only sending UE capability information after successfully receiving an AS security mode command (SMC) message when the message can be protected using the security context, regardless of when a UE capability enquiry is received by the UE.

Such an approach may provide privacy protection and protection against possible tampering attacks, at least according to some embodiments. However, it may be the case that a network can only provision a UE after it receives UE capability information, such that if the UE capability information is not sent until after the AS SMC is received, the network configuration of the UE may be impacted. Accordingly, as another possible approach, it may be possible to provide limited UE capability information to a cell prior to AS security establishment, and to provide full UE capability information to a cell after AS security establishment, or possibly even before AS security establishment if the UE has previously established AS security with the cell.

According to such an approach, whenever a UE performs AS security establishment on any cell, the UE may tag this cell (e.g., using a global cell identifier, such as PLMN ID+Cell ID) as a “secured cell for RRC procedure exchange” in a secure database or other memory. At least in some instances, such information may be stored in non-volatile storage of the UE, e.g., such that the record of having successfully established AS security with the cell may persist across power on/off cycles.

A certain set of features with respect to which the UE prefers not to indicate its capability before AS security establishment (e.g., features that can be enabled/activated before AS security establishment procedure and thus could be vulnerable to tampering, such as MFBI) may be determined by the UE. If the UE is requested by the network to perform a UE capability exchange procedure before an AS security establishment procedure, and if the serving cell of the UE is not found in the secured cell for RRC procedure exchange database, the UE may skip indicating support for the determined set of features when performing the UE capability exchange procedure. If the UE finds the cell in the secured cell for RRC procedure exchange database, then the UE may provide complete UE capability/feature set information when performing the UE capability exchange procedure.

If the UE does provide limited UE capability information (e.g., excluding the determined set of features) during the initial UE capability exchange procedure, and if the network does later establish AS security, then the UE may add this cell to the secured cell for RRC procedure exchange database, and may further perform a detach/re-attach procedure (e.g., if active voice or other high priority data transfer is not occurring) and then re-advertise the complete capability/feature set information so that the network can be fully aware of the UE's capability/feature set.

Note that as an alternative or additional approach to protecting UE capability information, in some instances, it may be possible for a UE to indicate a reduced capability (e.g., compared to its actual capability) when performing a UE capability exchange procedure with a cell that is not in the secured cell for RRC procedure exchange database prior to AS security establishment. The reduced capability may be sufficient to obtain the minimum necessary network configuration, for example. As one possibility, the part of the UE capability information that is sent before the AS SMC is received in such a scenario could include the AccessStratumRelease IE; in such a case, the UE could claim a lower release capability than its real capability; for example, if the AccessStratumRelease value of a UE is R15, it could choose to claim a different release (e.g., R7, R8, R11, or any other possible release value n where n<15). Thus, in such a scenario, the network may configure network resources for the UE in accordance with the indicated value of the AccessStratumRelease IE before the AS SMC is received, which may represent a lower capability set of network resources than the UE may actually be capable of handling. After the AS SMC is received, the complete and accurate UE capability information (e.g., including an indication of the actual AccessStratumRelease capability of the UE) may be provided, which may allow the network to configure updated network resources for the UE. Using such an approach, it may be the case that the network configuration procedure can be completed with less delay than if no UE capability information is provided before AS security is established, while still providing user privacy protection.

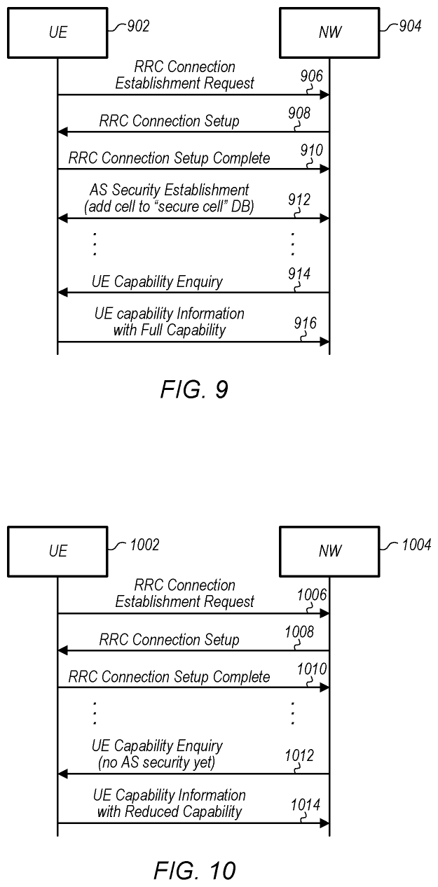

FIGS. 9-12 are signal flow diagrams illustrating various aspects of such a possible approach to performing a UE capability exchange procedure.

FIG. 9 illustrates signal flow aspects of a possible scenario in which security establishment is performed before a UE capability exchange procedure. As shown, a UE 902 may provide a RRC connection establishment request 906 to a network 904. The network 904 may respond with a RRC connection setup message 908. The UE 902 may follow up with a RRC connection setup complete message 910. In 912, the UE 902 and the network 904 may perform AS security establishment, and the UE 902 may add the serving cell to the secure cell database. After AS security establishment 912, the network 904 may send a UE capability enquiry 914 to the UE 902. As AS security has been established, the UE 902 may respond by providing a UE capability information message 916 that indicates the full capability of the UE 902.

FIG. 10 illustrates signal flow aspects of a possible scenario in which security establishment is not yet performed before a UE capability exchange procedure. As shown, a UE 1002 may provide a RRC connection establishment request 1006 to a network 1004. The network 1004 may respond with a RRC connection setup message 1008. The UE 1002 may follow up with a RRC connection setup complete message 1010. In 1012, the network 1004 may send a UE capability enquiry to the UE 1002. As AS security has not yet been established, and the serving cell is not found in the secure cell database, the UE 1002 may respond by providing a UE capability information message 1014 that indicates partial and/or reduced capability information for the UE 1002.

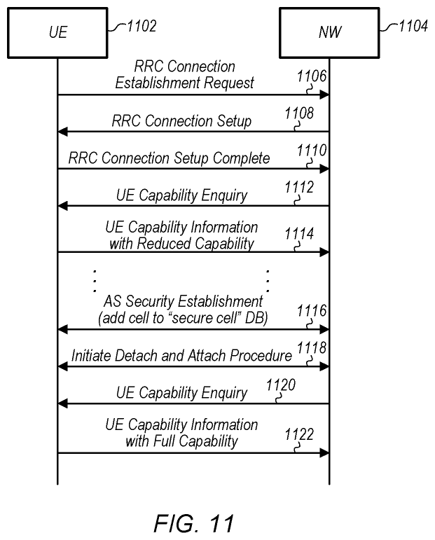

FIG. 11 illustrates signal flow aspects of a similar scenario in which security establishment is not yet performed before a UE capability exchange procedure. As shown, a UE 1102 may provide a RRC connection establishment request 1106 to a network 1104. The network 1104 may respond with a RRC connection setup message 1108. The UE 1102 may follow up with a RRC connection setup complete message 1110. In 1112, the network 1104 may send a UE capability enquiry to the UE 1102. As AS security has not yet been established, and the serving cell is not found in the secure cell database, the UE 1102 may respond by providing a UE capability information message 1114 that indicates partial and/or reduced capability information for the UE 1102. Subsequently, in 1116, the UE 1102 and the network 1104 may perform AS security establishment, and the UE 1102 may add the serving cell to the secure cell database. In 1118, the UE 1102 may initiate and perform a detach and attach procedure (or alternatively, may perform a TAU procedure) with the network 1104. The network 1104 may send another UE capability enquiry 1120 to the UE 1102 because of the detach and attach procedure 1118. In this case, as the serving cell is in the secure cell database, the UE 1102 may respond by providing a UE capability information message 1122 that indicates the full capability of the UE 1102.

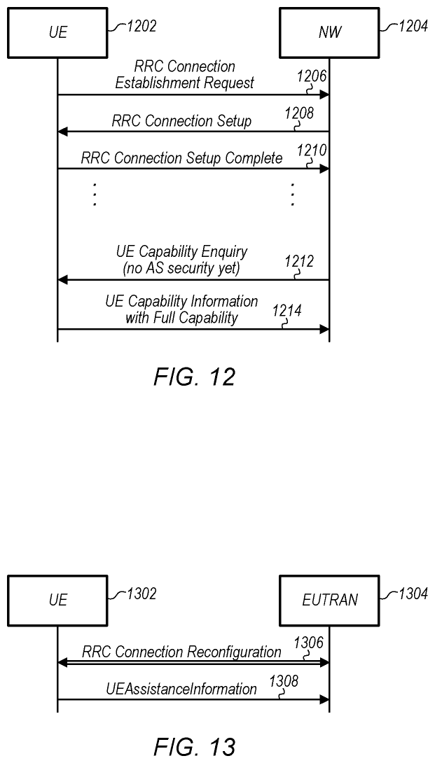

FIG. 12 illustrates signal flow aspects of a scenario in which security establishment is not yet performed before a UE capability exchange procedure, but in which the serving cell is in the secured cell database of the UE. As shown, a UE 1202 may provide a RRC connection establishment request 1206 to a network 1204. The network 1204 may respond with a RRC connection setup message 1208. The UE 1202 may follow up with a RRC connection setup complete message 1210. In 1212, the network 1204 may send a UE capability enquiry to the UE 1202. In this scenario, AS security has not yet been established, but the serving cell is found in the secure cell database, so the UE 1202 may respond by providing a UE capability information message 1214 that indicates the full capability of the UE 1202.

As previously noted, it may also be possible in some instances for an unauthorized party to obtain certain UE information from UE assistance information that a UE provides to the network, e.g., to facilitate implementation of power saving preferences of the UE, to provide a delay budget report, and/or for any of various other possible purposes, if such information is provided without AS security procedures having been completed. For example, such information may be usable to determine a product type (phone, watch, tablet, etc.), e.g., if such different product types have distinctive power saving preferences and/or other characteristics.

FIG. 13 is a signal flow diagram illustrating a possible scenario in which such a message could be provided. As shown, in the illustrated scenario a UE 1302 and a network (e.g., E-UTRAN) 1304 may perform RRC connection reconfiguration 1306, in which the network may configure the UE to be able to send a UEAssistanceInformation RRC message with certain types of UE assistance information. Once the UE 1302 has been configured, the UE 1302 may provide a UEAssistanceInformation RRC message 1308 to the network, e.g., on SRB1, potentially even without completion of the AS security procedure.

To avoid unintended use of such information, e.g., by a rogue/unauthorized cell, it may be possible for a UE to use a similar approach to limit sending such UE assistance information prior to AS security being established. For example, when a network has configured a UE to report UE assistance information for certain UE features and the UE has such UE assistance information to report, the UE may refrain from sending the UE assistance information to a cell if the cell is not identified in a secured cell database of the UE or if AS security has not yet been established. Otherwise (e.g., if the serving cell is identified in a secured cell database of the UE or if AS security has been established), the UE may proceed to send the UE assistance information. In addition, when AS security is not established and the cell is not part of the secured cell database, the UE may locally cache the UE assistance info, and only send it over the air once AS security gets established. Once AS security has been successfully established with a cell, the cell may be added to the secured cell database (or other type of memory) of the UE. Note that this secured cell database/memory may be the same secured cell database as previously described herein for determining if a cell is secure for a UE capability exchange procedure, or may be a different/separate database/memory, as desired. At least in some instances, as previously noted, such a database/memory may be stored in non-volatile/persistent memory.

In the following further exemplary embodiments are provided.

One set of embodiments may include an apparatus, comprising: a processing element configured to cause a wireless device to: establish a radio resource control (RRC) connection with a cell provided by a cellular base station; receive a capability enquiry from the cell; and determine how much capability information to provide in response to the capability enquiry based at least in part on whether access stratum security has been established between the wireless device and the cell when the capability enquiry is received.

According to some embodiments, the processing element is further configured to cause the wireless device to: determine to not provide capability information for the wireless device to the cell in response to the capability enquiry if access stratum security has not been established between the wireless device and the cell when the capability enquiry is received; determine to provide capability information for the wireless device to the cell in response to the capability enquiry if access stratum security has been established between the wireless device and the cell when the capability enquiry is received.

According to some embodiments, the processing element is further configured to cause the wireless device to: declare radio link failure if access stratum security has not been established between the wireless device and the cell when the capability enquiry is received.

According to some embodiments, if access stratum security has not been established between the wireless device and the cell when the capability enquiry is received, the processing element is further configured to cause the wireless device to: determine whether the wireless device has previously established access stratum security with the cell; wherein how much capability information to provide in response to the capability enquiry is determined further based at least in part on whether the wireless device has previously established access stratum security with the cell.

According to some embodiments, the processing element is further configured to cause the wireless device to: determine that the wireless device has previously established access stratum security with the cell; and provide full capability information to the cell while access stratum security has not been established between the wireless device and the cell based at least in part on determining that the wireless device has previously established access stratum security with the cell.

According to some embodiments, the processing element is further configured to cause the wireless device to: determine that the wireless device has not previously established access stratum security with the cell; provide partial capability information to the cell while access stratum security has not been established between the wireless device and the cell based at least in part on determining that the wireless device has not previously established access stratum security with the cell;

According to some embodiments, the processing element is further configured to cause the wireless device to: establish access stratum security with the cell; detach and re-attach or perform a tracking area update (TAU) procedure or perform a periodic registration update procedure with the cell based at least in part on having provided partial capability information to the cell and having established access stratum security with the cell.

According to some embodiments, the processing element is further configured to cause the wireless device to: establish access stratum security with the cell; and store information indicating that the wireless device has previously established access stratum security with the cell based at least in part on establishing access stratum security with the cell.

Another set of embodiments may include a wireless device, comprising: an antenna; a radio operably coupled to the antenna; and a processing element operably coupled to the radio; wherein the wireless device is configured to: establish a radio resource control (RRC) connection with a cellular base station; receive a capability enquiry from the cellular base station; determine whether access stratum security has been established between the wireless device and the cellular base station; and determine how much capability information to provide in response to the capability enquiry based at least in part on whether access stratum security has been established between the wireless device and the cellular base station when the capability enquiry is received.

According to some embodiments, the wireless device is further configured to: determine to provide full capability information if access stratum security has been established between the wireless device and the cellular base station when the capability enquiry is received or if the wireless device has previously established access stratum security with the cellular base station; and provide the full capability information in response to the capability enquiry.

According to some embodiments, the wireless device is further configured to: determine to provide partial and reduced capability information if access stratum security has not been established between the wireless device and the cellular base station when the capability enquiry is received and if the wireless device has not previously established access stratum security with the cellular base station, wherein the partial and reduced capability information indicates a capability that is lower than an actual capability of the wireless UE device with respect to one or more types of capability information; and provide the partial and reduced capability information in response to the capability enquiry.

According to some embodiments, the wireless device is further configured to: establish access stratum security with the cellular base station after providing the partial/reduced capability information in response to the capability enquiry; store information indicating that the wireless device has previously established access stratum security with the cellular base station based on establishing access stratum security with the cellular base station; detach from the cellular base station based at least in part on establishing access stratum security with the cellular base station after providing the partial/reduced capability information in response to the capability enquiry; re-attach to the cellular base station based at least in part on establishing access stratum security with the cellular base station after providing the partial/reduced capability information in response to the capability enquiry; receive a capability enquiry from the cellular base station after detaching from and re-attaching to the cellular base station; determine to provide full capability information in response to the capability enquiry received after detaching from and re-attaching to the cellular base station based at least in part on having previously established access stratum security with the cellular base station; and provide the full capability information in response to the capability enquiry received after detaching from and re-attaching to the cellular base station.

According to some embodiments, the wireless device is further configured to: determine to not provide capability information if access stratum security has not been established between the wireless device and the cellular base station when the capability enquiry is received.

According to some embodiments, the wireless device is further configured to: determine whether to provide wireless device assistance information to the cellular base station based at least in part on whether access stratum security has been established between the wireless device and the cellular base station, wherein assistance information is not provided if access stratum security has not been established between the wireless device and the cellular base station and if the wireless device has not previously established access stratum security with the cellular base station.

Yet another set of embodiments may include a method, comprising: by a wireless user equipment (UE) device: establishing a radio resource control (RRC) connection with a cellular base station; receiving a UE capability enquiry from the cellular base station, wherein the UE capability enquiry is received prior to access stratum (AS) security being established between the wireless UE device and the cellular base station; and determining how much capability information to provide in response to the UE capability enquiry based at least in part on the UE capability enquiry being received prior to AS security being established between the wireless UE device and the cellular base station.

According to some embodiments, the method further comprises: determining that the wireless UE device has previously established AS security with the cellular base station; determining to provide full capability information based at least in part on determining that the wireless UE device has previously established AS security with the cellular base station; and providing the full capability information in response to the UE capability enquiry.

According to some embodiments, the method further comprises: determining that the wireless UE device has not previously established AS security with the cellular base station; determining to provide reduced capability information based at least in part on determining that the wireless UE device has not previously established AS security with the cellular base station, wherein the reduced capability information indicates a capability that is lower than an actual capability of the wireless UE device with respect to one or more types of capability information; and providing the reduced capability information to the cellular base station in response to the UE capability enquiry.

According to some embodiments, the reduced capability information indicates a lower access stratum release capability than an actual access stratum release capability of the wireless UE device.

According to some embodiments, the method further comprises: determining to not provide capability information to the cellular base station in response to the UE capability enquiry based at least in part on receiving the UE capability enquiry from the cellular base station prior to AS security being established between the wireless UE device and the cellular base station; and determining that radio link failure has occurred based at least in part on receiving the UE capability enquiry from the cellular base station prior to AS security being established between the wireless UE device and the cellular base station.

According to some embodiments, the method further comprises: determining whether the wireless UE device has previously established AS security with the cellular base station; and determining whether to provide a UE assistance information message to the cellular base station prior to AS security being established between the wireless UE device and the cellular base station based at least in part on whether the wireless UE device has previously established AS security with the cellular base station, wherein the UE assistance information message is not provided prior to AS security being established between the wireless UE device and the cellular base station if the wireless UE device has not previously established AS security with the cellular base station.

A further exemplary embodiment may include a method, comprising: performing, by a wireless device, any or all parts of the preceding examples.

Another exemplary embodiment may include a device, comprising: an antenna; a radio coupled to the antenna; and a processing element operably coupled to the radio, wherein the device is configured to implement any or all parts of the preceding examples.

A further exemplary set of embodiments may include a non-transitory computer accessible memory medium comprising program instructions which, when executed at a device, cause the device to implement any or all parts of any of the preceding examples.

A still further exemplary set of embodiments may include a computer program comprising instructions for performing any or all parts of any of the preceding examples.

Yet another exemplary set of embodiments may include an apparatus comprising means for performing any or all of the elements of any of the preceding examples.

Still another exemplary set of embodiments may include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus, comprising:
a processing element configured to cause a wireless device to:
establish a radio resource control (RRC) connection with a cell provided by a cellular base station;
receive a capability enquiry from the cell; and
determine how much capability information to provide in response to the capability enquiry based at least in part on whether access stratum security has been established between the wireless device and the cell when the capability enquiry is received.

2. The apparatus of claim 1, wherein the processing element is further configured to cause the wireless device to:
determine to not provide capability information for the wireless device to the cell in response to the capability enquiry if access stratum security has not been established between the wireless device and the cell when the capability enquiry is received; and
determine to provide capability information for the wireless device to the cell in response to the capability enquiry if access stratum security has been established between the wireless device and the cell when the capability enquiry is received.

3. The apparatus of claim 2, wherein the processing element is further configured to cause the wireless device to:
declare radio link failure if access stratum security has not been established between the wireless device and the cell when the capability enquiry is received.

4. The apparatus of claim 1, wherein if access stratum security has not been established between the wireless device and the cell when the capability enquiry is received, the processing element is further configured to cause the wireless device to:
determine whether the wireless device has previously established access stratum security with the cell;
wherein how much capability information to provide in response to the capability enquiry is determined further based at least in part on whether the wireless device has previously established access stratum security with the cell.

5. The apparatus of claim 4, wherein the processing element is further configured to cause the wireless device to:
determine that the wireless device has previously established access stratum security with the cell; and
provide full capability information to the cell while access stratum security has not been established between the wireless device and the cell based at least in part on determining that the wireless device has previously established access stratum security with the cell.

6. The apparatus of claim 4, wherein the processing element is further configured to cause the wireless device to:
determine that the wireless device has not previously established access stratum security with the cell;
provide partial and/or reduced capability information to the cell while access stratum security has not been established between the wireless device and the cell based at least in part on determining that the wireless device has not previously established access stratum security with the cell;

7. The apparatus of claim 6, wherein the processing element is further configured to cause the wireless device to:
establish access stratum security with the cellular base station;
detach and re-attach or perform a tracking area update (TAU) procedure or perform a periodic registration update procedure with the cell based at least in part on having provided partial capability information to the cell and having established access stratum security with the cell.

8. The apparatus of claim 1, wherein the processing element is further configured to cause the wireless device to:
establish access stratum security with the cell; and
store information indicating that the wireless device has previously established access stratum security with the cell based at least in part on establishing access stratum security with the cell.

9. A wireless device, comprising:
an antenna;
a radio operably coupled to the antenna; and
a processing element operably coupled to the radio;
wherein the wireless device is configured to:
establish a radio resource control (RRC) connection with a cellular base station;
receive a capability enquiry from the cellular base station;
determine whether access stratum security has been established between the wireless device and the cellular base station; and
determine how much capability information to provide in response to the capability enquiry based at least in part on whether access stratum security has been established between the wireless device and the cellular base station when the capability enquiry is received.

10. The wireless device of claim 9, wherein the wireless device is further configured to:
determine to provide full capability information if access stratum security has been established between the wireless device and the cellular base station when the capability enquiry is received or if the wireless device has previously established access stratum security with the cellular base station; and
provide the full capability information in response to the capability enquiry.

11. The wireless device of claim 9, wherein the wireless device is further configured to:
determine to provide partial and reduced capability information if access stratum security has not been established between the wireless device and the cellular base station when the capability enquiry is received and if the wireless device has not previously established access stratum security with the cellular base station, wherein the partial and reduced capability information indicates a capability that is lower than an actual capability of the wireless UE device with respect to one or more types of capability information; and
provide the partial and reduced capability information in response to the capability enquiry.

12. The wireless device of claim 11, wherein the wireless device is further configured to:
establish access stratum security with the cellular base station after providing the partial and reduced capability information in response to the capability enquiry;
store information indicating that the wireless device has previously established access stratum security with the cellular base station based on establishing access stratum security with the cellular base station;
detach from the cellular base station based at least in part on establishing access stratum security with the cellular base station after providing the partial and reduced capability information in response to the capability enquiry;
re-attach to the cellular base station based at least in part on establishing access stratum security with the cellular base station after providing the partial and reduced capability information in response to the capability enquiry;
receive a capability enquiry from the cellular base station after detaching from and re-attaching to the cellular base station;
determine to provide full capability information in response to the capability enquiry received after detaching from and re-attaching to the cellular base station based at least in part on having previously established access stratum security with the cellular base station; and
provide the full capability information in response to the capability enquiry received after detaching from and re-attaching to the cellular base station.

13. The wireless device of claim 9, wherein the wireless device is further configured to:
determine to not provide capability information if access stratum security has not been established between the wireless device and the cellular base station when the capability enquiry is received.

14. The wireless device of claim 9, wherein the wireless device is further configured to:
determine whether to provide wireless device assistance information to the cellular base station based at least in part on whether access stratum security has been established between the wireless device and the cellular base station,
wherein assistance information is not provided if access stratum security has not been established between the wireless device and the cellular base station and if the wireless device has not previously established access stratum security with the cellular base station.

15. A method, comprising:
by a wireless user equipment (UE) device:
establishing a radio resource control (RRC) connection with a cellular base station;
receiving a UE capability enquiry from the cellular base station, wherein the UE capability enquiry is received prior to access stratum (AS) security being established between the wireless UE device and the cellular base station; and
determining how much capability information to provide in response to the UE capability enquiry based at least in part on the UE capability enquiry being received prior to AS security being established between the wireless UE device and the cellular base station.

16. The method of claim 15, wherein the method further comprises:
determining that the wireless UE device has previously established AS security with the cellular base station;
determining to provide full capability information based at least in part on determining that the wireless UE device has previously established AS security with the cellular base station; and
providing the full capability information in response to the UE capability enquiry.

17. The method of claim 15, wherein the method further comprises:
determining that the wireless UE device has not previously established AS security with the cellular base station;
determining to provide reduced capability information based at least in part on determining that the wireless UE device has not previously established AS security with the cellular base station, wherein the reduced capability information indicates a capability that is lower than an actual capability of the wireless UE device with respect to one or more types of capability information; and
providing the reduced capability information to the cellular base station in response to the UE capability enquiry.

18. The method of claim 17,
wherein the reduced capability information indicates a lower access stratum release capability than an actual access stratum release capability of the wireless UE device.

19. The method of claim 15, wherein the method further comprises:
determining to not provide capability information to the cellular base station in response to the UE capability enquiry based at least in part on receiving the UE capability enquiry from the cellular base station prior to AS security being established between the wireless UE device and the cellular base station; and
determining that radio link failure has occurred based at least in part on receiving the UE capability enquiry from the cellular base station prior to AS security being established between the wireless UE device and the cellular base station.

20. The method of claim 15, wherein the method further comprises:
determining whether the wireless UE device has previously established AS security with the cellular base station; and
determining whether to provide a UE assistance information message to the cellular base station prior to AS security being established between the wireless UE device and the cellular base station based at least in part on whether the wireless UE device has previously established AS security with the cellular base station,
wherein the UE assistance information message is not provided prior to AS security being established between the wireless UE device and the cellular base station if the wireless UE device has not previously established AS security with the cellular base station.
